(19) United States
(12) Patent Application Publication
(10) Pub. No.: US 2007/0271286 A1
(43) Pub. Date: Nov. 22, 2007

(54) Dimensionality reduction for content category data

(76) Inventors: Khemdut Purang, San Jose, CA (US); Mark Plutowski, Santa Cruz, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/435,448

(22) Filed: May 16, 2006

(51) Int. Cl. G06F 7/00

(52) U.S. Cl. 707/101

(57) ABSTRACT

The dimensionality of a content category dataset is reduced based on the categories and the relationship between the content and categories. The category dataset includes names of categories and relation data, where the relation data defines a relationship between the categories and content. The dimensionality of a category dataset is reduced by determining a number of subsets of the category dataset and generating new relation data, where the new relation data defines a relationship between the category dataset subsets and the content.

### RELATED APPLICATIONS

This patent application is related to the co-pending U.S. patent application, entitled “CLUSTERING AND CLASSIFICATION OF CATEGORICAL DATA”, attorney docket no. 080398.P649, application Ser. No. ______. The related co-pending application is assigned to the same assignee as the present application.

### TECHNICAL FIELD

This invention relates generally to multimedia, and more particularly to reducing the number of natural language terms needed to describe content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2005, Sony Electronics, Incorporated, All Rights Reserved.

### BACKGROUND

Clustering and classification tend to be important operations in certain data mining applications. For instance, data within a dataset may need to be clustered and/or classified in a data system with a purpose of assisting a user in searching and automatically organizing content, such as recorded television programs, electronic program guide entries, and other types of multimedia content.

Generally, many clustering and classification algorithms work well when the dataset is numerical (i.e., when datum within the dataset are all related by some inherent similarity metric or natural order). Numerical datasets often describe a single attribute or category. Categorical datasets, on the other hand, describe multiple attributes or categories that are often discrete, and therefore, lack a natural distance or proximity measure between them.

### SUMMARY

The dimensionality of a content category dataset is reduced based on the categories and the relationship between the content and categories. The category dataset includes names of categories and relation data, where the relation data defines a relationship between the categories and content. The dimensionality of a category dataset is reduced by determining a number of subsets of the category dataset and generating new relation data, where the new relation data defines a relationship between the category dataset subsets and the content.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

The present invention is illustrated by way of example and not limitation in the figures of the accompanying drawings in which like references indicate similar elements.

FIG. 1A illustrates one embodiment of a multimedia database system.

FIG. 1B illustrates one embodiment of content metadata.

FIG. 2 illustrates one embodiment of a category dataset ontology.

FIG. 3 is a flow chart of one embodiment of a method for reducing the dimensionality of the category dataset ontology.

FIG. 4 is a flow chart of one embodiment of a method to partition the category dataset ontology for use with the method at FIG. 3.

FIG. 5 is a flow chart of another embodiment of a method to partition the category dataset ontology for use with the method at FIG. 3.

FIG. 6 is a flow chart of one embodiment of a method for building a term based hierarchy for use with the method at FIG. 5.

FIG. 7 is a flow chart of one embodiment of a method for building a term based hierarchy subtree for use with the method at FIG. 5.

FIG. 8 is a flow chart of one embodiment of a method for splitting the term based hierarchy for use with the method at FIG. 5.

FIG. 9 is a flow chart of one embodiment of a method of generating a mapping of old terms to new terms for use with the method at FIG. 3.

FIG. 10 is a flow chart of one embodiment of a method for creating the relation between the content and new terms for use with the method at FIG. 9.

FIG. 11 is a block diagram illustrating one embodiment of a device that reduces the dimensionality of the category dataset ontology.

FIG. 12 is a diagram of one embodiment of an operating environment suitable for practicing the present invention.

FIG. 13 a diagram of one embodiment of a computer system suitable for use in the operating environment of FIGS. 3-10.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

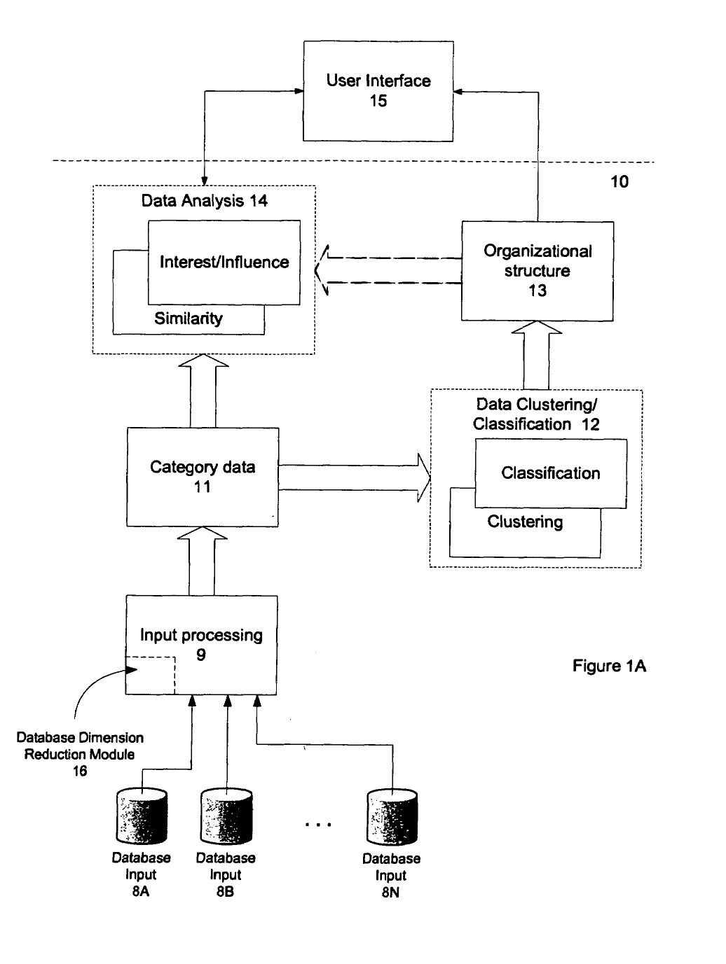

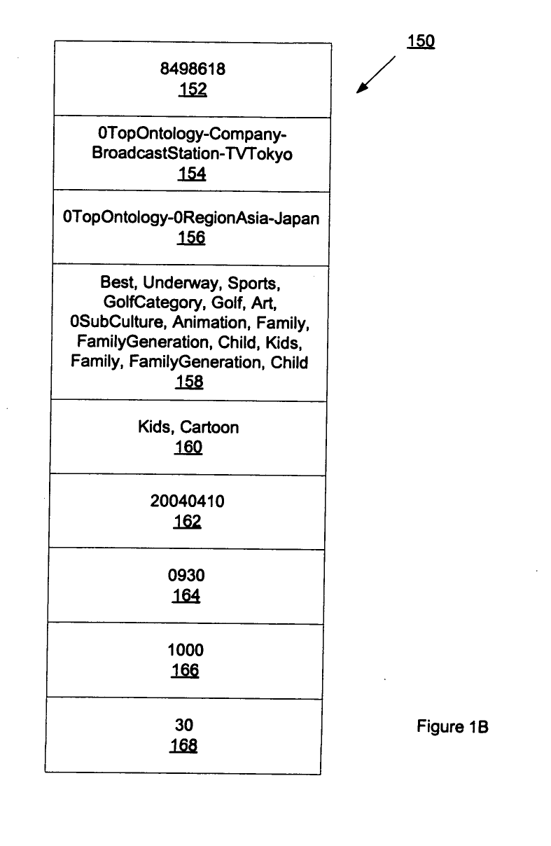

FIG. 1A is a diagram of a data system 10 that enables automatic recommendation or selection of information, such as content, which can be characterized by category data 11. Category data, also referred to as category dataset, describes multiple attributes or categories. Each category comprises category names and relation data, where the relation data define the relationship between the category and one or more particular pieces of content. The word “term” referred to herein is a category name. In one embodiment, category data has a dimension based on the number of terms and the term relations. The more terms and/or term relations in category data, the greater the dimensionality of category data. Conversely, reducing the number of terms and/or term relations, the smaller the dimensionality of the category data.

Furthermore, category data can be sparse, which means that the category data has a large dimensionality. In one embodiment, the category data is sparse because the categories are discrete and lack a natural similarity measure between them. Examples of category data include electronic program guide (EPG) data, and content metadata. The data system 10 includes an input processing module 9 to preprocess and load the category data 11 from database inputs 8A-N.

The category data 11 is grouped into clusters, and/or classified into folders by the clustering/classification module 12. Details of the clustering and classification performed by module 12 are below. The output of the clustering/classification module 12 is an organizational data structure 13, such as a cluster tree or a dendrogram. A cluster tree may be used as an indexed organization of the category data or to select a suitable cluster of the data.

Many clustering applications require identification of a specific layer within a cluster tree that best describes the underlying distribution of patterns within the category data. In one embodiment, organizational data structure 13 includes an optimal layer that contains a unique cluster group containing an optimal number of clusters.

A data analysis module 14 may use the folder-based classifiers and/or classifiers generated by clustering operations for automatic recommendation or selection of content. The data analysis module 14 may automatically recommend or provide content that may be of interest to a user or may be similar or related to content selected by a user. In one embodiment, a user identifies multiple folders of category data records that categorize specific content items, and the data analysis module 14 assigns category data records for new content items with the appropriate folders based on similarity.

A user interface 15 also shown in FIG. 1A is designed to assist the user in searching and automatically organizing content using the data system 10. Such content may be, for example, recorded TV programs, electronic program guide (EPG) entries, and multimedia content.

Clustering is a process of organizing category data into a plurality of clusters according to some similarity measure among the category data. The module 12 clusters the category data by using one or more clustering processes, including seed based hierarchical clustering, order-invariant clustering, and subspace bounded recursive clustering. In one embodiment, the clustering/classification module 12 merges clusters in a manner independent of the order in which the category data is received.

In one embodiment, the group of folders created by the user may act as a classifier such that new category data records are compared against the user-created group of folders and automatically sorted into the most appropriate folder. In another embodiment, the clustering/classification module 12 implements a folder-based classifier based on user feedback. The folder-based classifier automatically creates a collection of folders, and automatically adds and deletes folders to or from the collection. The folder-based classifier may also automatically modify the contents of other folders not in the collection.

In one embodiment, the clustering/classification module 12 may augment the category data prior to or during clustering or classification. One method for augmentation is by imputing attributes of the category data. The augmentation may reduce any scarceness of category data while increasing the overall quality of the category data to aid the clustering and classification processes.

Although shown in FIG. 1A as specific separate modules, the clustering/classification module 12, organizational data structure 13, and the data analysis module 14 may be implemented as different separate modules or may be combined into one or more modules.

Furthermore, database input module 9 comprises database dimension reduction module 15. As stated above, category datasets can be sparse. Reducing the dimensionality of the datasets improves the efficiency and quality of modules using the datasets, because the datasets are denser and easier to search and/or process. In one embodiment, database dimension reduction module 15 reduces the dimensionality of category dataset 11 by modifying the term relations between the terms in category dataset 11 and the content. A term relation is data that define the relationship between a term in category data 11 and the one or more particular pieces of content associated with that term. In another embodiment, database dimension reduction module 15 reduces the dimensionality of category dataset 11 by reducing the number of terms in category dataset 11.

In one embodiment, database input module 9 extracts category data for a particular piece of content from content metadata. Content metadata is information that describes content used by data system 10. FIG. 1B illustrates one embodiment of content metadata 150 for a particular content processed by database input module 9. In FIG. 1B, content metadata 150 comprises program identifier 152, station broadcaster 154, broadcast region 156, category data 158, genre 160, date 162, start time 164, end time 166, and duration 168. Furthermore, content metadata 150 may include additional fields (not shown). Program identifier 152 identifies the content used by data system 10. Station broadcaster 154 and broadcast region 156 identify the broadcaster and the region where content was displayed. In addition, content metadata 150 identifies the date and time the content was displayed with date 162, start time 164, end time 166. Duration 168 is the duration of the content. Furthermore, genre describes the genre associated with the content.

Category data for a particular piece of content is one or more terms that describe the different categories associated with the piece of content. As illustrated in FIG. 1B, category data 158 comprises the terms: Best, Underway, Sports, GolfCategory, Golf, Art, 0SubCulture, Animation, Family, FamilyGeneration, Child, Kids, Family, FamilyGeneration, and Child. Thus, category data 158 comprises fifteen terms describing the program. Some of the terms are related, for example, “Sports, GolfCategory, Golf” are related to sports, and “Family, FamilyGeneration, Child, Kids”, are related to family. Furthermore, category data 158 includes duplicate terms and possibly undefined terms (0SubCulture). Undefined terms are associated with one program, because the definition is unknown.

In FIG. 1B, category data 158 comprises a large number of terms. Because there are a large number of terms for one piece of content, the size of the category dataset 11 can grow to be quite large for multiple pieces of content. For example, a week of television programming could have thousands of programs with thousands of individual terms describing the programs. In addition, many of the terms could be associated with one program, thus resulting in the category dataset 11 that is large and sparse. A large and sparse database is difficult for modules that process the database to utilize efficiently.

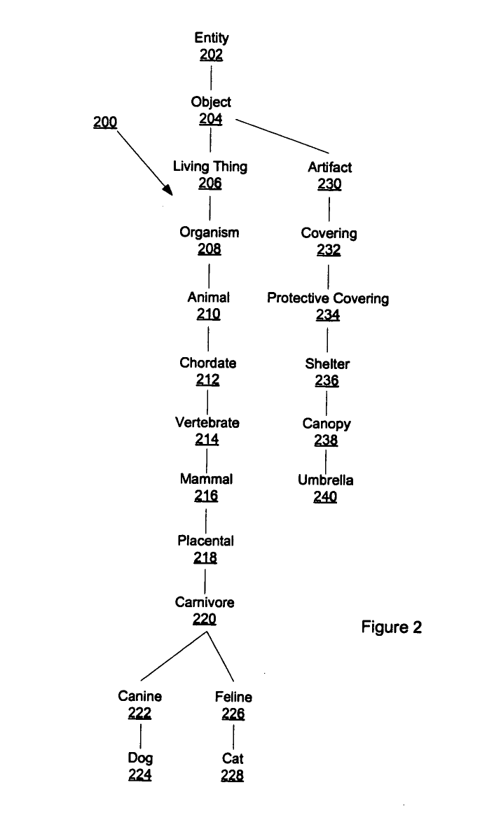

One embodiment of database dimension reduction module 15 that reduces the dimensionality of category dataset 11 uses a category dataset ontology. FIG. 2 illustrates one embodiment of category dataset ontology 200. An ontology is a system that relates terms together, such as nouns. An example of an ontology known in the art is WordNet, which is a taxonomy of nouns. A category dataset ontology is an ontology used to relate different categorical terms that could describe different content, such as, but not limited to, video, audio, images, text, books, etc. For example, ontology 200 is a relation of hypernyms 204-240. A hypernym is a noun that is more generic than another noun. For example, animal is more generic than dog, because a dog is a specific type of animal. In other words, a hypernym represents a “is-a” relationship, as in “a dog is an animal.”

Ontology 200 comprises entity 202, object 204, living thing 206, organism 208, animal 210, chordate 212, vertebrate 214, mammal 216, placental 218, carnivore 220, canine 222, dog 224, feline 226, cat 228, artifact 230, covering 232, protective covering 234, shelter 236, canopy 238, umbrella 240. Entity 202 is the top most hypernym of category dataset ontology 200. The top most hypernym in the ontology is also known as the root node and is the most generic term in the ontology tree. Thus, in ontology 200, entity 202 is the most generic term and every term below entity 202 “is an” entity. Object 204 is a hyernym of living thing 206 and artifacts 230, as well as the nouns 208-228 and 232-240 below living thing 206 and artifact 230, respectively. The structure of category dataset ontology 200 illustrates two main branches: one branch relating living things 206 and the other branch relating artifacts 230. Living thing 206 branch comprises the following hypernyms (in terms of more generic to more specific): organism 208, animal 210, chordate 212, vertebrate 214, mammal 216, placental 218, carnivore 220. Under carnivore 220, ontology 200 splits into two branches: canine 222/dog 224 and feline 226/cat 228. Canine 222 is a hypernym of dog 224. Similarly, feline 226 is a hypernym of cat 228.

The second maim branch of ontology 200 comprises the following hypernyms (in terms of more generic to more specific): artifact 230, covering 232, protective covering 234, shelter 236, canopy 238, and umbrella 240.

In one embodiment, database dimension reduction module 15 uses ontology 200 to determine relatedness between categorical terms. In one embodiment, term relatedness is determined by the closeness of terms in ontology 200 by counting the number of hops to get from one term to the other. For example, dog 224 and cat 228 are closer to each other than to umbrella 240. This is because, based on ontology 200, cat 228 is four terms away from dog 224 whereas umbrella 240 is sixteen terms distant from dog 224.

This degree of relatedness can be used to group terms by sub-attributes. Each term in ontology 200 can attributes. Grouping the terms by relatedness associates sub-attributes with a term. In one embodiment, each term in the group is related to the other terms as a sub-attribute. Using a group size limitation restricts the total number of terms within each group (e.g., how far to traverse an ontology to group terms). A bound is used herein to refer to a group size limitation or size limitation on a hierarchy sub-tree. Hierarchy sub-trees are described further below.

For example, a grouping of categorical dataset attributes could be:

(Recreation, Pachinko, Fun Entertainment, Encore, Swimming, Skating, Gymnastics, Hunting, Fishing, Tennis, Basketball, Golf, Soccer, Baseball, Athletics) (1)

(Tofu, Food, Diet, Vitamin, Sushi, Soup, Pudding, Dessert, Chocolate, Beverage) (2)

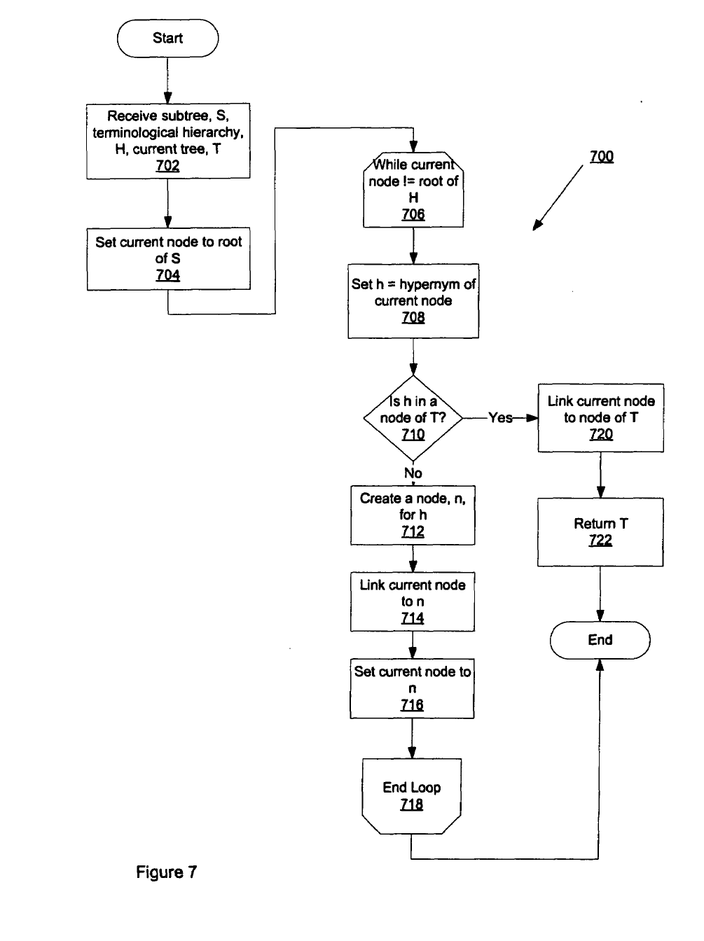

Using this grouping, database dimension reduction module 15 adds to a term attributes corresponding to each other term in the group. Furthermore, the groups have intuitive meaning and a smaller set of values. For example, group (1) could be seen as an attribute for types of recreations while group (2) could be food attributes. An algorithm can distinguish the terms based on the semantically related terms. Of course, alternate embodiments could have different results. For example, alternate embodiments can employ different ontologies with more, less and/or different classes and structures. One embodiment of grouping terms by sub-attributes is further described in FIG. 7, described below. Grouping the terms reduces the sparsity of the term relations because each term in the group is related to every other term of the group. Thus, grouping terms by sub-attribute can modify the defined term relation between the grouped terms and the content associated with the grouped terms.

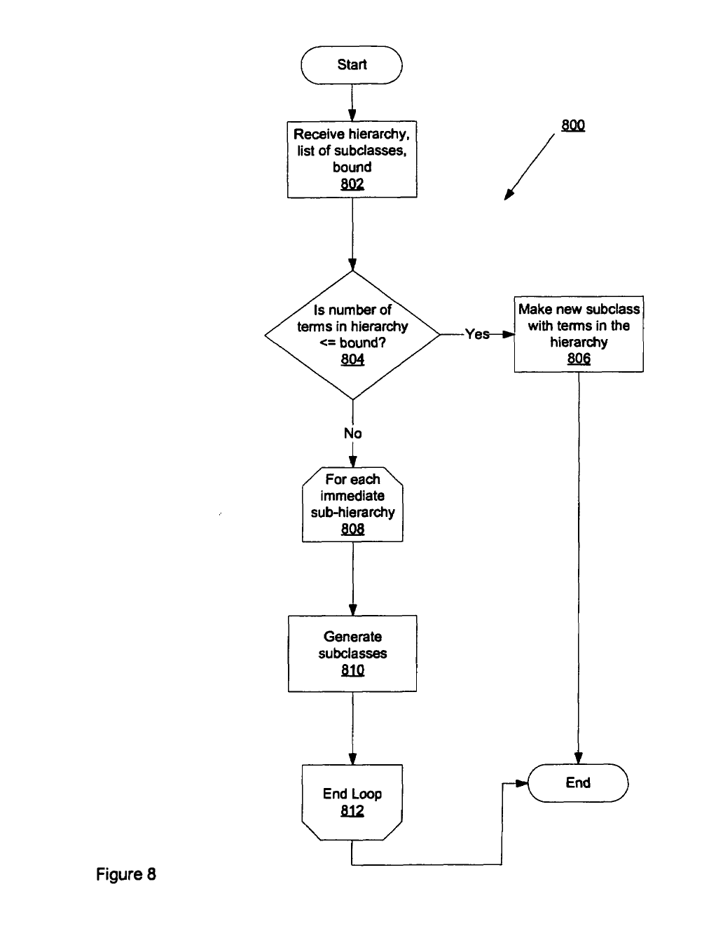

In an alternate embodiment, instead of splitting term attributes into sub-attributes, database dimension input module 15 replaces terms with more generic terms. Replacing multiple terms with a generic term reduces the overall dimensionality of category data 11. In one embodiment terms are mapped onto a hypernym of the term. On the other hand, in alternate embodiments, a term is mapped onto another related term that is not a hypernym. Term replacement results in fewer terms in ontology 200 as several terms are mapped onto the same abstract term. The resulting data is much less sparse, because each term is associated with more multimedia data and there are proportionately more terms associated with each multimedia data. The degree of abstraction can be controlled by specifying the desired statistical properties of the resulting terms. In one embodiment, the degree of abstraction is controlled mapping the generic term to each leaf node in ontology 200 directly below the generic term. For example, an EPG dataset (Brother, Sister, Grandchild, Baby, Infant, Son, Daughter, Husband, Mother, Parent, Father) is mapped onto ‘relative’, and EPG dataset (Hunting, Fishing, Gymnastics, Basketball, Tennis, Golf, Soccer, Football, Baseball) is mapped onto ‘sport’. As with grouping terms by sub-attribute, term replacement modifies the term relation because one or more terms in category data 11 are replaced by generic terms. One embodiment of replacing terms is further described in FIG. 8, described below.

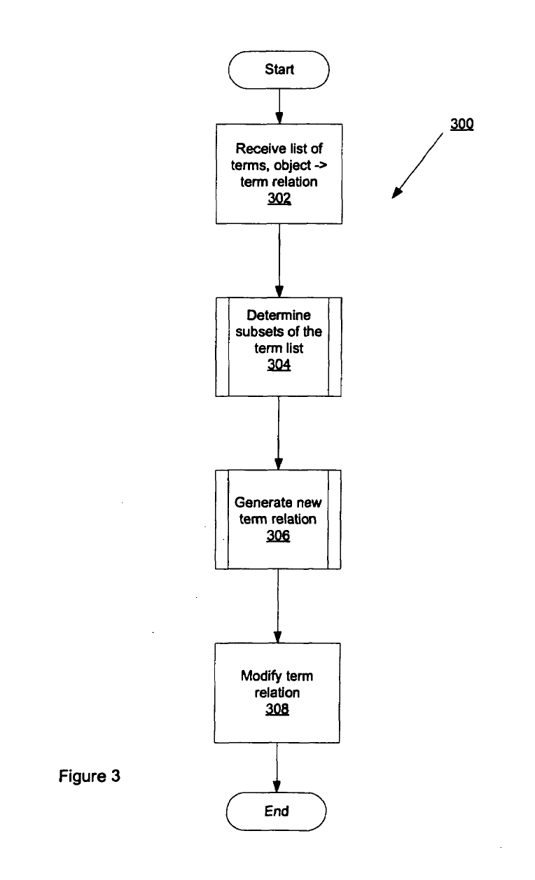

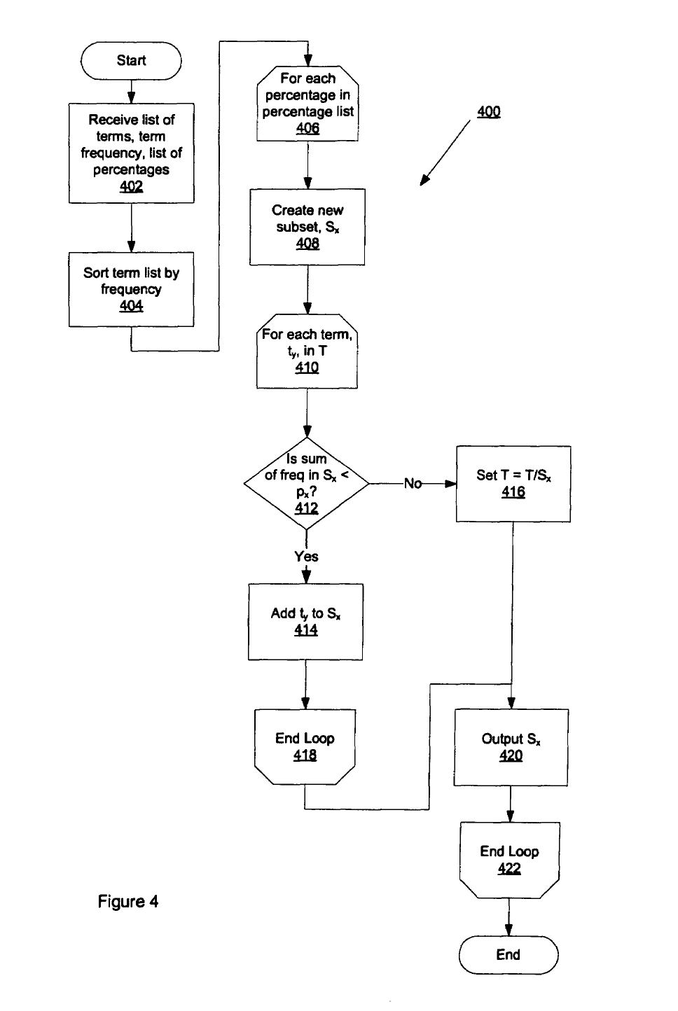

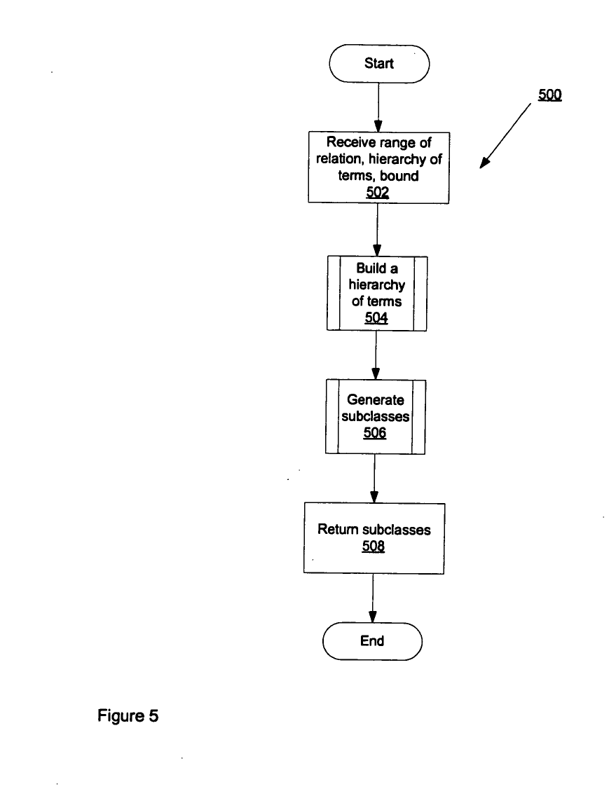

FIG. 3 is a flow chart of one embodiment of method 300 for reducing the dimensionality of the category dataset ontology. In FIG. 3, at block 302, method 300 receives the list of terms in the category dataset and the content to term relation. For example, if method 300 received the information for content metadata 150, method 300 receives the term list “Best, Underway, Sports, GolfCategory, Golf, Art, 0SubCulture, Animation, FamilyGeneration, Child, Kids” and the term relations associated with program ID 152. At block 304, method 300 determines the subsets of the term list. Generating term list subsets reduce the number of independent terms in the term list by relating subsets of multiple terms to one term. In one embodiment, method 300 generates term subsets based on the frequency of term occurrence as described in FIG. 4 below. In an alternate embodiment, method 300 groups terms using the category dataset ontology as described in FIGS. 5-8 below.

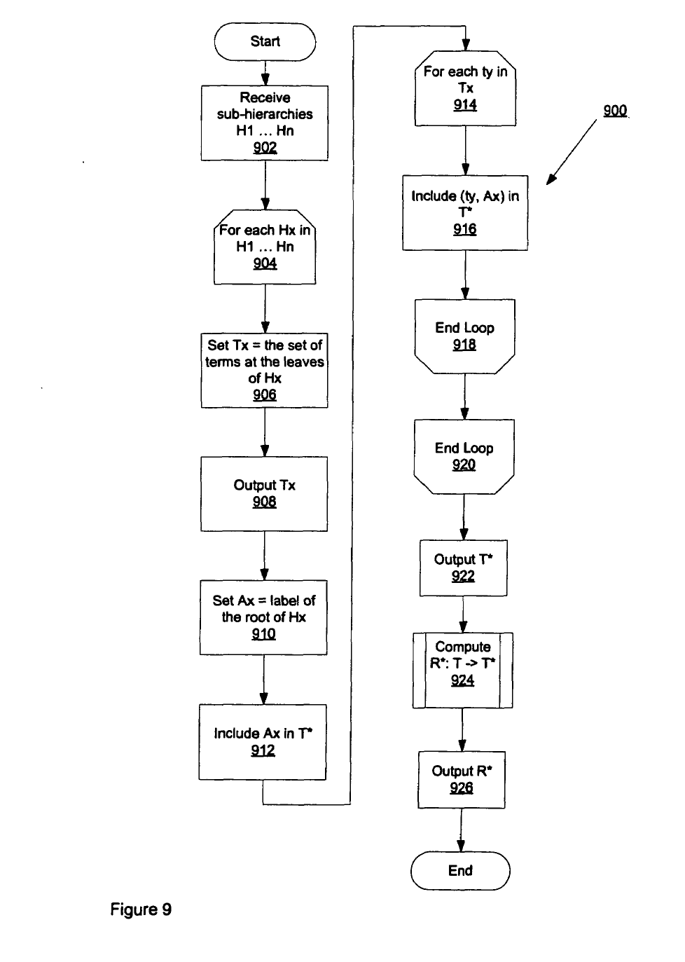

At block 306, method 300 uses the term list subsets to generate new term relations. As stated above, a term relation relates particular pieces of content to a term in category dataset 11. By using the term list subsets, method 300 reduces the dimensionality of the term relation. Reducing the term relation dimensionality allows for a more efficient search or other allocation of machine resources in processing category datasets. Term relation dimensionality reduction is further described in FIG. 9 below.

At block 308, method 300 modifies the term relation. In one embodiment, method 300 replaces the old term relation with the new, reduced dimension term relation. In another embodiment, method 300 updates the old relation with the new reduced dimension term relation.

FIG. 4 is a flow chart of one embodiment of method 400 to partition the category dataset ontology based on the frequency of term occurrence. Because the category dataset can be sparse, the frequency of a term occurring in the categorical dataset could be as low as one occurrence. Furthermore, many of the terms could be deleted from the term list prior to partitioning. In our embodiment, terms are deleted in the term appears only once or the term relation. In alternate embodiments, terms are deleted with a higher frequency. At block 402, method 400 receives the term list, term frequency and term percentage list. In one embodiment, the term frequency and percentage list is determined by counting the number of each term occurrence in the data and computing a term occurrence percentage. At block 404, method 400 sorts the term list based on the term frequency.

Method 400 further executes an outer processing loop (blocks 406-422) to create term list subset based on the sorted term list. At block 408, method 400 creates a new term subset, Sₓ. In one embodiment, method 400 creates an empty set for Sₓ.

Furthermore, method 400 executes an inner processing loop (blocks 410-418) to add terms to the subset based on the term frequency. At block 412, method 400 determines if the sum of the frequencies of the terms in Sₓ is less than percentage pₓ. If so, at block 414, method 400 adds t_{y} to Sₓ. Otherwise, method 400 sets the term list, T, to be the set difference between the old term list, T, and the term subset, Sₓ. This gives a new term list T that does not have any of the term listed in Sₓ. The inner processing loop ends at block 418. At block 420, method 400 outputs Sₓ. The outer processing loop ends at block 422.

FIG. 5 is a flow chart of one embodiment of method 500 to partition the category dataset ontology by grouping terms into subsets. At block 502, method 500 receives the range of term relation, hierarchy over terms and a bound. In one embodiment, the hierarchy of terms is a category dataset ontology, such as ontology 200. Alternatively, the hierarchy of terms can be a restrictive ontology with fewer relations than the category dataset ontology. The bound represents the maximum number terms allowed per subset. In one embodiment, the bound is an input to method 500 and is typically set by an operator. The bound can be a good balance between efficiency and quality of results and depends on the type of data input to method 500.

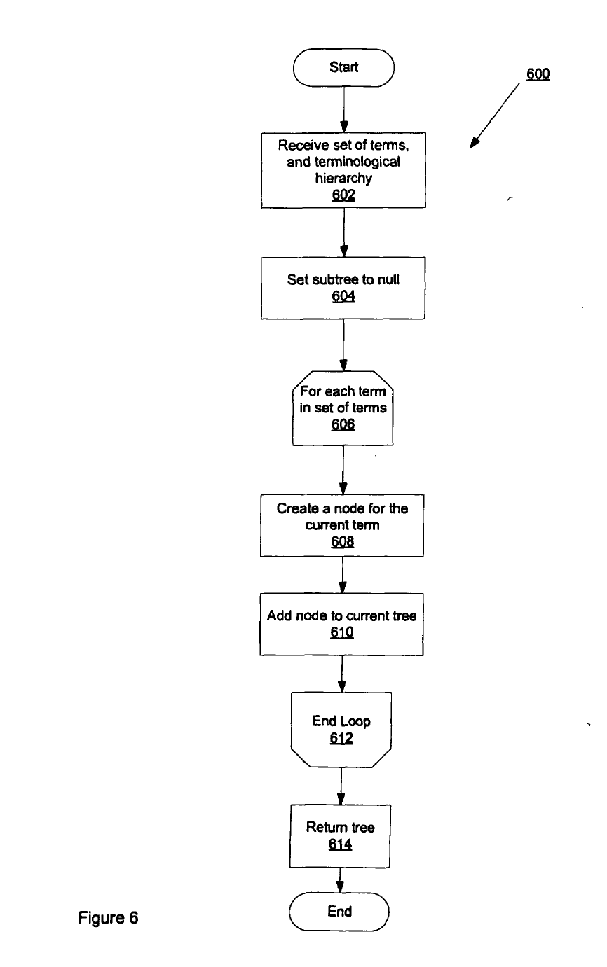

At block 504, method 500 builds a hierarchy of terms. A hierarchy of terms describes the inter-relation of terms. For instance, category dataset ontology 200 is an example of a hierarchy of terms. In this embodiment, the hierarchy of term is a hypernym term hierarchy. Building a hierarchy term is further described in FIG. 6 below.

At block 506, method 500 generates subclasses from the hierarchy of terms. Sub-classing groups the terms by the sub-attribute of the term. Generating subclasses is further described in FIG. 7 below. Method 500 returns the subclasses at block 508.

FIG. 6 is a flow chart of one embodiment of method 600 for building a term based hierarchy. At block 602, method 600 receives a set of terms and a terminological hierarchy. In one embodiment, the term list and hierarchy is the same as in FIG. 5. In alternate embodiments, method 600 receives this term list and hierarchy from another source (stored on the local or remote media, etc.). At block 604, method 600 sets the subtree, S, to null.

Method 600 further executes a processing loop (blocks 606-612) to add terms in the hierarchy to the subtree, S. At block 606, method 600 creates a node for the current term, tᵢ, being processed. Method 600 adds the node to subtree S at block 610. The processing loop ends at block 612. Method 600 returns the subtree S at block 614.

FIG. 7 is a flow chart of one embodiment of method 700 for building a term based hierarchy subtree. At block 702, method 700 receives the subtree S generated by method 600 in Figure above, the terminological hierarchy H, and the current tree T. In one embodiment, T is the tree to which S is to be added. Alternatively, T can be a null tree. At block 704, method 700 sets the current node to the root node of subtree S.

Method 700 further executes a processing loop (blocks 706-718) to link the terms in subtree S to hypernyms of the term in terminological hierarchy H. At block 706, method 700 sets h to be a hypernym of the current node. At block 700, method 700 determines if h is a node of T. If not, at block 712, method 700 creates node n for h and links the current node to the new node n. Method 700 sets the current to node n at block 716. Execution proceeds to block 718 where the processing loop ends.

If h is a node of T, method 700 breaks out of processing loop and links the current node to the node in T at block 720. At block 722, method 700 returns tree T.

FIG. 8 is a flow chart of one embodiment of method 800 for splitting the term based hierarchy based on a bound. As stated above, the bound limits the number of terms in a hierarchy sub-tree. At block 802, method 800 receives the hierarchy of terms H, list of subclasses Sᵢ, and the bound. At block 804, method 800 determines if the number of terms in the hierarchy is less than or equal to the bound. If so, at block 806, method 800 creates new subclasses with the terms in the hierarchy.

If the number of terms in the hierarchy is greater than the bound, method 800 further executes a processing loop (blocks 808-812) to generate additional subclasses from the term hierarchy. At block 808, method 800 executes the loop for each sub-hierarchy in the term hierarchy. In one embodiment, a sub-hierarchy is a leaf directly below the hierarchy root node. In alternate embodiments, method 800 partitions the term hierarchy into different sub-hierarchies (e.g., removing sub-trees from the hierarchy tree, etc.). At block 810, method 800 generates subclasses from the new sub-hierarchies. The processing loop ends at block 812.

FIG. 9 is a flow chart of one embodiment of a method 900 of generating a mapping of old terms to new terms to reduce the dimensionality of category dataset 11. In one embodiment, the sub-hierarchies are the ones generated in FIG. 8. In alternate embodiments, the sub-hierarchies, are generated by another scheme. At block 902, method 900 receives the sub-hierarchies, H₁ . . . H_{N}. Method 900 further executes an outer processing loop (blocks 904-918) to generate the mapping for each sub-hierarchy, Hₓ. At block 906, method 900 sets Tₓ equal to the set of terms at the leaves of Hₓ. Method 900 outputs Tₓ at block 908. In one embodiment, Tₓ is the set of leaves that get mapped to the abstract term. At block 910, method 900 sets Aₓ equal to the label of the root of Hₓ. Method 900 includes Aₓ in T* at block 912.

Method 900 further executes an inner processing loop (blocks 914-918) to generate the term relations for T* for each term t_{y} in Tₓ. At block 916, method 900 includes the term relation (t_{y}, Aₓ) in T*. In one embodiment, Tₓ is the set of terms and T* is the mappings. For examples, a term relation can be (term, abstract term). The inner and outer processing loops end at blocks 918, 920, respectively.

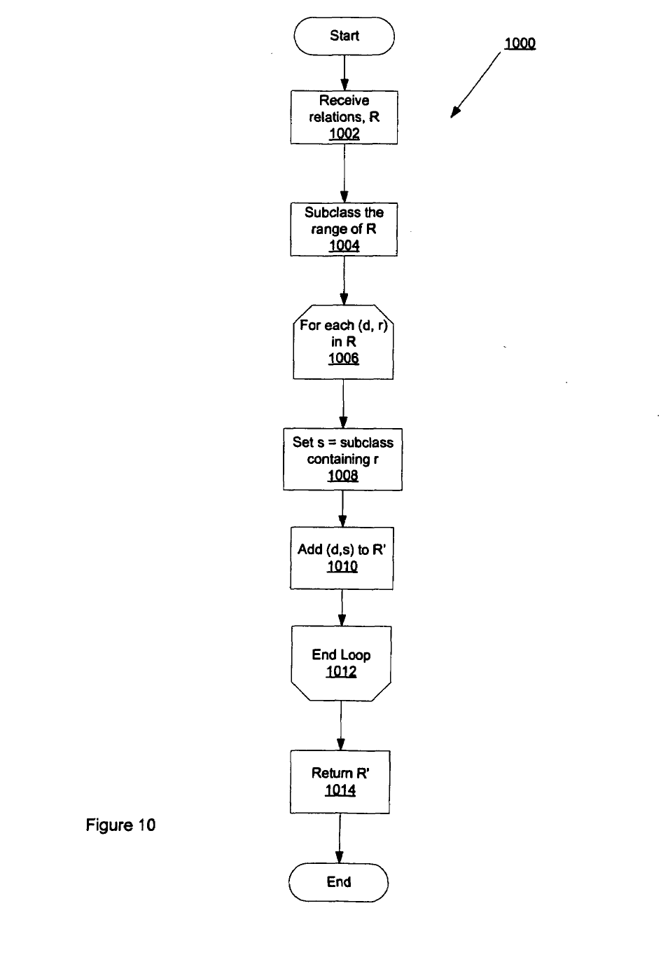

At block 922, method 900 outputs T*, which represents the new list of terms. At block 924, method 900 computes R*, which is the changes in the term relation from T to T*. Computing the new relation R* is further described in FIG. 10, below. Method 900 outputs R* at block 926.

FIG. 10 is a flow chart of one embodiment of a method 1000 for creating the relation between the content and new list of terms. In one embodiment, the new list of terms T* is generated in FIG. 9. In alternate embodiments, the new list of terms is retrieved from an alternate source, and/or computed in different manners known in the art. At block 1002, method 1000 receives the relations R. As described above, R describes the relation between the terms in the category datasets and the content. For example, R could be a one-way relationship for the category dataset to content, the content to category dataset and/or both. At block 1004, method 1000 subclasses the range of R. In one embodiment, sub-classing R groups the term to content relation by term sub-attribute.

Method 1000 further executes a processing loop (blocks 1006-1012) to assign individual term relations (d, r) to a relation subclass. At block 1008, method 1000 set s equal to the subclass containing r. In one embodiment, r is in a single sub-class. At block 1010, method 1000 adds (d, s) to R′. The processing loop ends at 1012. Method 1014 returns the modified relation R′ at block 1014.

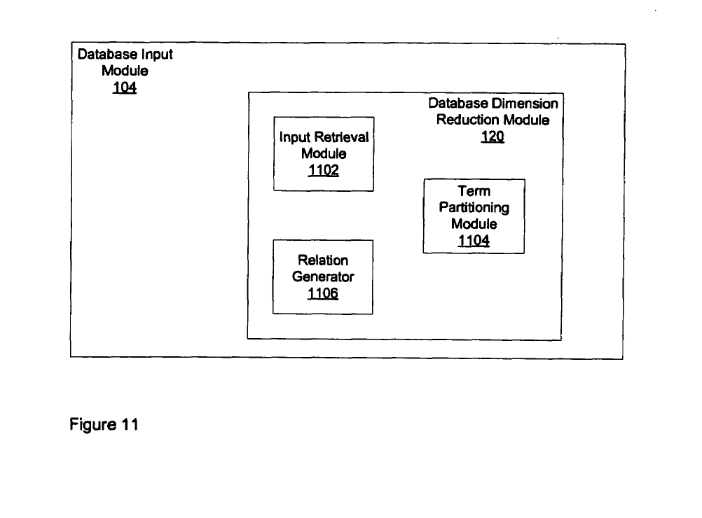

FIG. 11 is a block diagram illustrating one embodiment of a device that reduces the dimensionality of the category dataset ontology. In one embodiment, database input module 104 contains database dimension reduction module 106. Alternatively, database input module 104 does not contain database dimension reduction module 106, but is coupled to dimension reduction module 120. Database dimension reduction module 106 comprises input retrieval module 1102, term partitioning module 1104, and relation generator 1106. Input retrieval module 1102 receives the list of terms, object to term relations as described in FIG. 3, block 302. Term partitioning module 1104 determines the subsets of the term list as described in FIG. 3, block 304. While in one embodiment, term partitioning module 1104 partitions the term list based on the frequency of term occurrence, in alternate embodiments, term partition module 1106 partitions the term list using different ways (grouping terms using the category dataset ontology, etc.). Relation generator 1106 generates new term relations using the term list partitioning as described in FIG. 3, block 306. In addition, relation generator 1106 updates or replaces the old term relation with the new term relation.

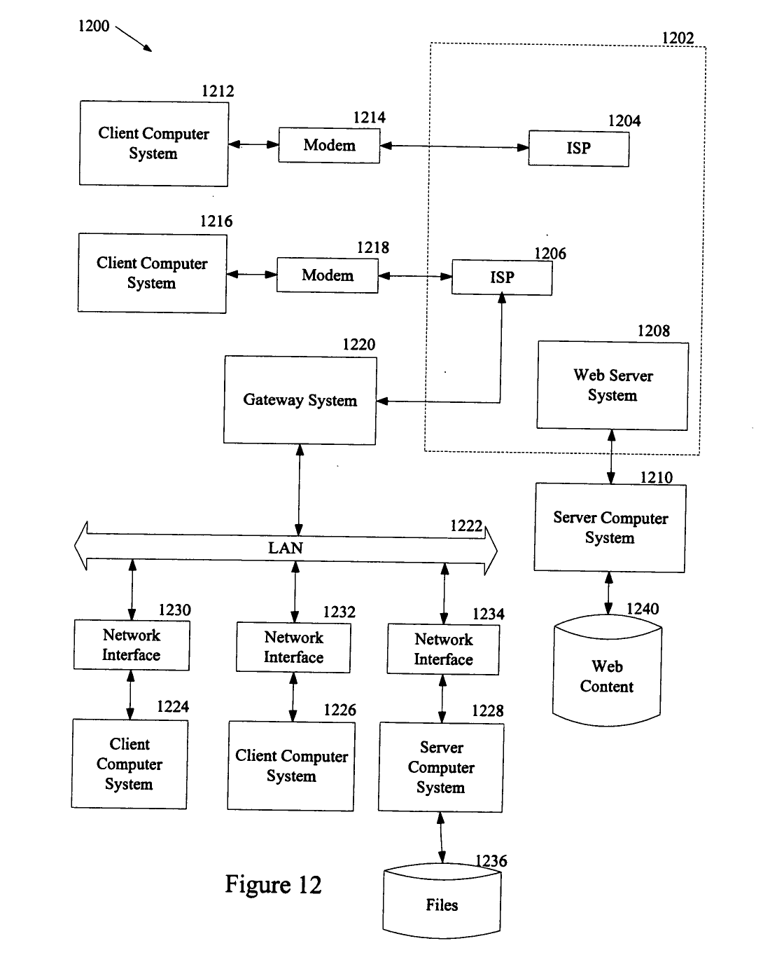

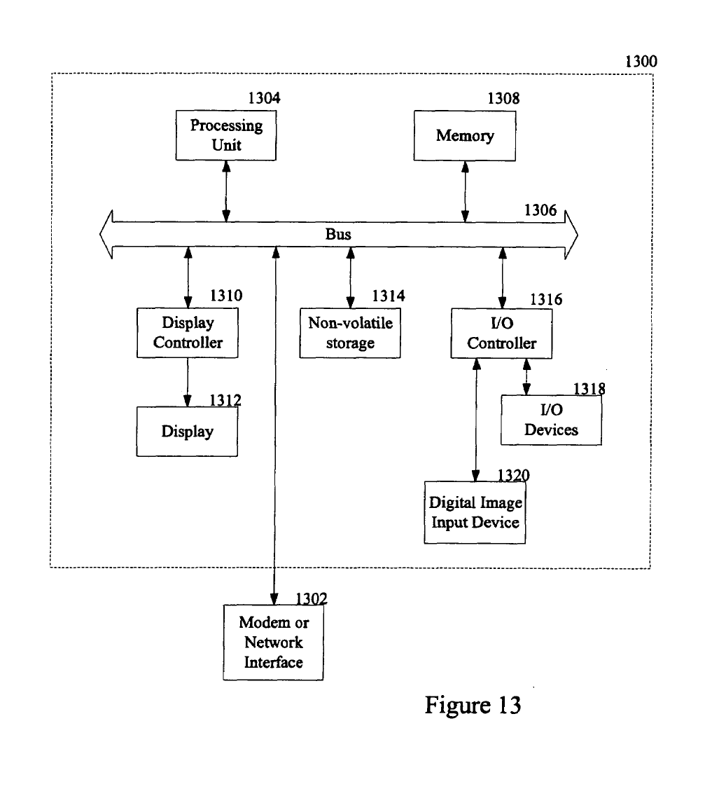

The following descriptions of FIGS. 12-13 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

In practice, the methods described herein may constitute one or more programs made up of machine-executable instructions. Describing the method with reference to the flowchart in FIGS. 3-10 enables one skilled in the art to develop such programs, including such instructions to carry out the operations (acts) represented by logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in the flow diagrams without departing from the scope of the invention and that no particular order is implied by the arrangement of blocks shown and described herein.

FIG. 12 shows several computer systems 1200 that are coupled together through a network 1202, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 1202 is typically provided by Internet service providers (ISP), such as the ISPs 1204 and 1206. Users on client systems, such as client computer systems 1212, 1216, 1224, and 1226 obtain access to the Internet through the Internet service providers, such as ISPs 1204 and 1206. Access to the Internet allows users of the client computer systems to exchange information, receive and send e-mails, and view documents, such as documents which have been prepared in the HTML format. These documents are often provided by web servers, such as web server 1208 which is considered to be “on” the Internet. Often these web servers are provided by the ISPs, such as ISP 1204, although a computer system can be set up and connected to the Internet without that system being also an ISP as is well known in the art.

The web server 1208 is typically at least one computer system which operates as a server computer system and is configured to operate with the protocols of the World Wide Web and is coupled to the Internet. Optionally, the web server 1208 can be part of an ISP which provides access to the Internet for client systems. The web server 1208 is shown coupled to the server computer system 1210 which itself is coupled to web content 1240, which can be considered a form of a media database. It will be appreciated that while two computer systems 1208 and 1210 are shown in FIG. 12, the web server system 1208 and the server computer system 1210 can be one computer system having different software components providing the web server functionality and the server functionality provided by the server computer system 1210 which will be described further below.

Client computer systems 1212, 1216, 1224, and 1226 can each, with the appropriate web browsing software, view HTML pages provided by the web server 1208. The ISP 1204 provides Internet connectivity to the client computer system 1212 through the modem interface 1214 which can be considered part of the client computer system 1212. The client computer system can be a personal computer system, a network computer, a Web TV system, a handheld device, or other such computer system. Similarly, the ISP 1206 provides Internet connectivity for client systems 1216, 1224, and 1226, although as shown in FIG. 12, the connections are not the same for these three computer systems. Client computer system 1216 is coupled through a modem interface 1218 while client computer systems 1224 and 1226 are part of a LAN. While FIG. 12 shows the interfaces 1214 and 1218 as generically as a “modem,” it will be appreciated that each of these interfaces can be an analog modem, ISDN modem, cable modem, satellite transmission interface, or other interfaces for coupling a computer system to other computer systems. Client computer systems 1224 and 1216 are coupled to a LAN 1222 through network interfaces 1230 and 1232, which can be Ethernet network or other network interfaces. The LAN 1222 is also coupled to a gateway computer system 1220 which can provide firewall and other Internet related services for the local area network. This gateway computer system 1220 is coupled to the ISP 1206 to provide Internet connectivity to the client computer systems 1224 and 1226. The gateway computer system 1220 can be a conventional server computer system. Also, the web server system 1208 can be a conventional server computer system.

Alternatively, as well-known, a server computer system 1228 can be directly coupled to the LAN 1222 through a network interface 1234 to provide files 1236 and other services to the clients 1224, 1226, without the need to connect to the Internet through the gateway system 1220. Furthermore, any combination of client systems 1212, 1216, 1224, 1226 may be connected together in a peer-to-peer network using LAN 1222, Internet 1202 or a combination as a communications medium. Generally, a peer-to-peer network distributes data across a network of multiple machines for storage and retrieval without the use of a central server or servers. Thus, each peer network node may incorporate the functions of both the client and the server described above.

FIG. 13 shows one example of a conventional computer system that can be used as encoder or a decoder. The computer system 1300 interfaces to external systems through the modem or network interface 1302. It will be appreciated that the modem or network interface 1302 can be considered to be part of the computer system 1300. This interface 1302 can be an analog modem, ISDN modem, cable modem, token ring interface, satellite transmission interface, or other interfaces for coupling a computer system to other computer systems. The computer system 1302 includes a processing unit 1304, which can be a conventional microprocessor such as an Intel Pentium microprocessor or Motorola Power PC microprocessor. Memory 1308 is coupled to the processor 1304 by a bus 1306. Memory 1308 can be dynamic random access memory (DRAM) and can also include static RAM (SRAM). The bus 1306 couples the processor 1304 to the memory 1308 and also to non-volatile storage 1314 and to display controller 1310 and to the input/output (I/O) controller 1316. The display controller 1310 controls in the conventional manner a display on a display device 1312 which can be a cathode ray tube (CRT) or liquid crystal display (LCD). The input/output devices 1318 can include a keyboard, disk drives, printers, a scanner, and other input and output devices, including a mouse or other pointing device. The display controller 1310 and the I/O controller 1316 can be implemented with conventional well known technology. A digital image input device 1320 can be a digital camera which is coupled to an I/O controller 1316 in order to allow images from the digital camera to be input into the computer system 1300. The non-volatile storage 1314 is often a magnetic hard disk, an optical disk, or another form of storage for large amounts of data. Some of this data is often written, by a direct memory access process, into memory 1308 during execution of software in the computer system 1300. One of skill in the art will immediately recognize that the terms “computer-readable medium” and “machine-readable medium” include any type of storage device that is accessible by the processor 1304 and also encompass a carrier wave that encodes a data signal.

Network computers are another type of computer system that can be used with the embodiments of the present invention. Network computers do not usually include a hard disk or other mass storage, and the executable programs are loaded from a network connection into the memory 1308 for execution by the processor 1304. A Web TV system, which is known in the art, is also considered to be a computer system according to the embodiments of the present invention, but it may lack some of the features shown in FIG. 13, such as certain input or output devices. A typical computer system will usually include at least a processor, memory, and a bus coupling the memory to the processor.

It will be appreciated that the computer system 1300 is one example of many possible computer systems, which have different architectures. For example, personal computers based on an Intel microprocessor often have multiple buses, one of which can be an input/output (I/O) bus for the peripherals and one that directly connects the processor 1304 and the memory 1308 (often referred to as a memory bus). The buses are connected together through bridge components that perform any necessary translation due to differing bus protocols.

It will also be appreciated that the computer system 1300 is controlled by operating system software, which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 1314 and causes the processor 1304 to execute the various acts required by the operating system to input and output data and to store data in memory, including storing files on the non-volatile storage 1314.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computerized method comprising:
receiving a category dataset and a current relation data, wherein the category dataset comprises terms that describe a particular piece of content and the current relation data defines a relationship between the terms in the category dataset and the particular piece of content;
determining subsets of the category dataset, wherein a number of subsets is less than a number of terms in the category dataset, wherein each subset comprises at least one term;
generating new relation data, wherein the new relation data defines a new relationship between the subsets and the particular piece of content.

2. The computerized method of claim 1, further comprising replacing each subset with a generic term.

3. The computerized method of claim 1, wherein the subsets is determined using a frequency of occurrence for each term in the category data.

4. The computerized method of claim 1, further comprising:
grouping the terms into the subsets.

5. The computerized method of claim 1, further comprising:
generating a term hierarchy from the category data.

6. The computerized method of claim 5, further comprising:
splitting the term hierarchy according to a bound.

7. A machine readable medium comprising:
receiving a category dataset and a current relation data, wherein the category dataset comprises terms that describe a particular piece of content and the current relation data defines a relationship between the terms in the category dataset and the particular piece of content;
determining subsets of the category dataset, wherein a number of subsets is less than a number of terms in the category dataset, wherein each subset comprises at least one term;
generating new relation data, wherein the new relation data defines a new relationship between the subsets and the particular piece of content.

8. The machine readable medium of claim 7, further comprising replacing each subset with a generic term.

9. The machine readable medium of claim 7, wherein the subsets is determined using a frequency of occurrence for each term in the category data.

10. The machine readable medium of claim 7, further comprising:
grouping the terms into the subsets.

11. The machine readable medium of claim 7, further comprising:
generating a term hierarchy from the category data.

12. The machine readable medium of claim 11, further comprising:
splitting the term hierarchy according to a bound.

13. A apparatus comprising:
means for receiving a category dataset and a current relation data, wherein the category dataset comprises terms that describe a particular piece of content and the current relation data defines a relationship between the terms in the category dataset and the particular piece of content;
means for determining subsets of the category dataset, wherein a number of subsets is less than a number of terms in the category dataset, wherein each subset comprises at least one term;
means for generating new relation data, wherein the new relation data defines a new relationship between the subsets and the particular piece of content.

14. The apparatus of claim 13, further comprising:
means for grouping the terms into the subsets.

15. The apparatus of claim 13, further comprising:
means for generating a term hierarchy from the category data.

16. The apparatus of claim 15, further comprising:
means for splitting the term hierarchy according to a bound.

17. A system comprising:
a processor;
a memory coupled to the processor though a bus; and
a process executed from the memory by the processor to cause the processor to receive a category dataset and a current relation data, wherein the category dataset comprises terms that describe a particular piece of content and the current relation data defines a relationship between the terms in the category dataset and the particular piece of content, to determine subsets of the category dataset, wherein a number of subsets is less than a number of terms in the category dataset, wherein each subset comprises at least one term, to generate new relation data, wherein the new relation data defines a new relationship between the subsets and the particular piece of content.

18. The system of claim 17, wherein the process further causes the processor to group the terms into the subsets.

19. The system of claim 17, wherein the process further causes the processor to generate a term hierarchy from the category data.

20. The system of claim 19, wherein the process further causes the processor to split the term hierarchy according to a bound.
